(19) United States
(12) Patent Application Publication
(10) Pub. No.: US 2016/0351320 A1
(43) Pub. Date: Dec. 1, 2016

(54) COIL ELECTRONIC COMPONENT

(71) Applicant: SAMSUNG ELECTRO-MECHANICS CO., LTD., Suwon-si (KR)

(72) Inventor: Dong Jin JEONG, Suwon-si (KR)

(21) Appl. No.: 15/088,887

(22) Filed: Apr. 1, 2016

(30) Foreign Application Priority Data
May 29, 2015 (KR) 10-2015-0075951

(51) Int. Cl. H01F 27/28; H01F 27/255; H01F 27/29

(52) U.S. Cl. CPC H01F 27/2804; H01F 27/292; H01F 27/255

(57) ABSTRACT

A coil electronic component includes a substrate; a coil pattern formed on at least one of first and second main surfaces of the substrate; and a body region filling a core region of the coil pattern and having a magnetic material, wherein a part formed at an outermost portion of the coil pattern and a part of the coil pattern closest to the core region have a thickness less than that of internal patterns positioned therebetween.

### CROSS-REFERENCE TO RELATED APPLICATION

This application claims benefit of priority to Korean Patent Application No. 10-2015-0075951 filed on May 29, 2015, with the Korean Intellectual Property Office, the disclosure of which is incorporated herein by reference.

### TECHNICAL FIELD

The present disclosure relates to a coil electronic component.

### BACKGROUND

An inductor corresponding to a coil electronic component is a representative passive element configuring an electronic circuit together with a resistor and a capacitor to remove noise.

The inductor may be classified into a multilayer type inductor, a thin film type inductor, and the like. Among them, the thin film type inductor is appropriate for being relatively thinly manufactured. Therefore, the thin film type inductor has recently been utilized in various fields, and an attempt to further decrease thickness of a component has been continuously conducted in accordance with the trend toward complexation, multi-functionalization, and slimness of set components. Accordingly, a scheme capable of securing high performance and reliability in spite of the trend toward the slimness of the coil electronic component in the related art has been demanded.

### SUMMARY

An aspect of the present disclosure may provide a coil electronic component capable of having improved direct current (DC) bias characteristics by appropriately adjusting a thickness of a coil pattern included in the coil electronic component to control a flow of magnetic flux in a core.

According to an aspect of the present disclosure, a coil electronic component may include: a substrate; a coil pattern formed on at least one of first and second main surfaces of the substrate; and a body region filling a core region of the coil pattern and having a magnetic material, wherein a part formed at an outermost portion of the coil pattern and a part of the coil pattern closest to the core region have a thickness less than that of internal patterns positioned therebetween.

Due to the coil pattern having the thickness distribution as described above, a flow of magnetic flux in a core may become smooth, and thus DC bias characteristics may be improved.

### BRIEF DESCRIPTION OF DRAWINGS

The above and other aspects, features, and advantages of the present disclosure will be more clearly understood from the following detailed description taken in conjunction with the accompanying drawings, in which:

FIG. 1 is a perspective view schematically illustrating an appearance of a coil electronic component according to an exemplary embodiment in the present disclosure;

FIG. 2 is a cross-sectional view taken along line A-A′ of FIG. 1; and

FIG. 3 is a cross-sectional view taken along line B-B′ of FIG. 1.

### DETAILED DESCRIPTION

Hereinafter, embodiments of the present disclosure will be described in detail with reference to the accompanying drawings.

The disclosure may, however, be embodied in many different forms and should not be construed as being limited to the embodiments set forth herein. Rather, these embodiments are provided so that this disclosure will be thorough and complete, and will fully convey the scope of the disclosure to those skilled in the art.

In the drawings, the shapes and dimensions of elements maybe exaggerated for clarity, and the same reference numerals will be used throughout to designate the same or like elements.

Coil Electronic Component

Hereinafter, a coil electronic component according to an exemplary embodiment, particularly, a thin film type inductor, will be described by way of example. However, the coil electronic component according to an exemplary embodiment is not necessarily limited thereto.

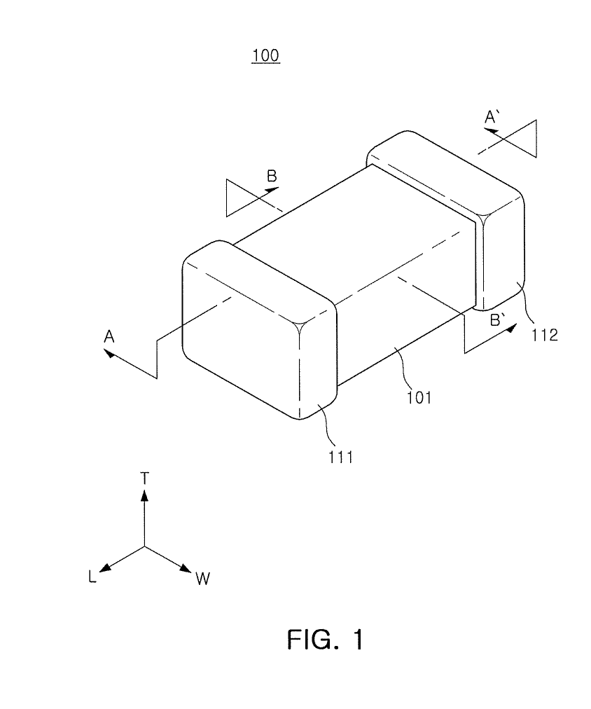

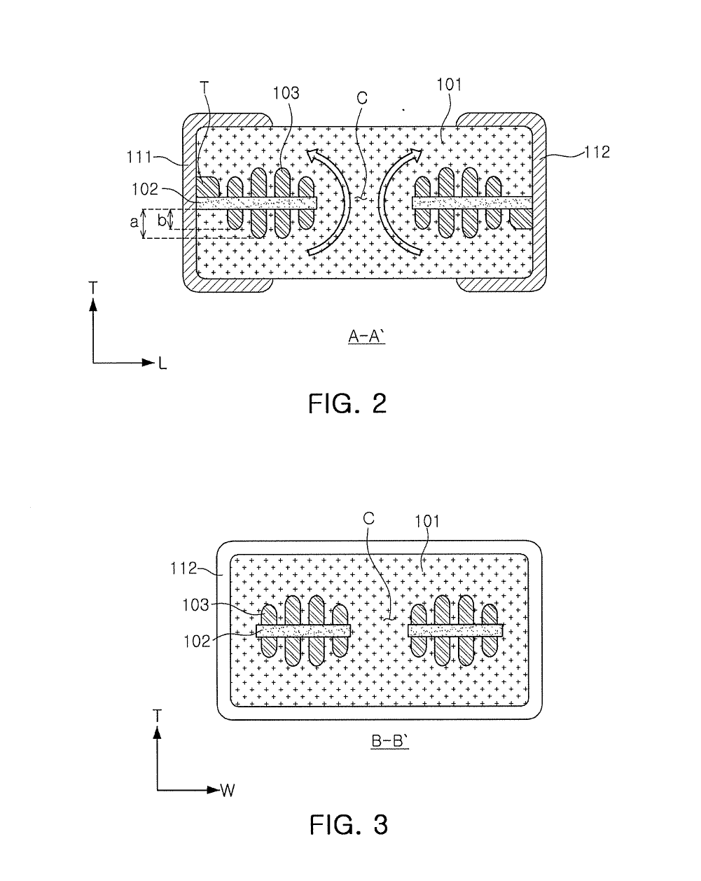

FIG. 1 is a perspective view schematically illustrating an appearance of a coil electronic component according to an exemplary embodiment. In addition, FIG. 2 is a cross-sectional view taken along line A-A′ of FIG. 1, and FIG. 3 is a cross-sectional view taken along line B-B′ of FIG. 1. In this case, in the following description described with reference to FIG. 1, a ‘length’ direction refers to an ‘L’ direction of FIG. 1, a ‘width’ direction refers to a ‘W’ direction of FIG. 1, and a ‘thickness’ direction refers to a ‘T’ direction of FIG. 1.

Referring to FIGS. 1 through 3, a coil electronic component 100 according to an exemplary embodiment may include a substrate 102, a coil pattern 103, a body region 101, and external electrodes 111 and 112.

The substrate 102 may be disposed in the body region 101 to serve to support the coil pattern 103, and may be, for example, a polypropylene glycol (PPG) substrate, a ferrite substrate, a metal based soft magnetic substrate, or the like. In this case, a through-hole maybe formed in a central region of the substrate 102, and a magnetic material may be provided in the through-hole to form a core region C. The core region C may configure a portion of the body region 101. As described above, the core region C formed of the magnetic material may improve performance of the coil electronic component 100.

The coil pattern 103 may be formed on at least one of first and second main surfaces of the substrate 102. In the present exemplary embodiment, the coil patterns 103 are formed on both of the first and second main surfaces of the substrate 102 in order to obtain high inductance. That is, a first coil pattern may be formed on the first main surface of the substrate 102, and a second coil pattern may be formed on the second main surface of the substrate 102 opposing the first main surface of the substrate 102. In this case, the first and second coil patterns may be electrically connected to a via (not illustrated) penetrating through the substrate 102. In addition, the coil pattern 103 may have a spiral shape, and may include a lead portion T formed at the outermost portion of the coil pattern having the spiral shape. The lead portion T is exposed to the outside of the body region 101 for the purpose of electrical connection to the external electrodes 111 and 112.

The coil pattern 103 may be formed of a metal having high electrical conductivity, such as silver (Ag), palladium (Pd), aluminum (Al), nickel (Ni), titanium (Ti), gold (Au), copper (Cu), platinum (Pt), or alloys thereof. In this case, as an example of a preferable process for manufacturing a thin film shape, an electroplating method may be used. Alternatively, other processes known in the related art may also be used as long as an effect similar to an effect of the electroplating method may be accomplished.

In the present exemplary embodiment, the coil pattern 103 may be formed at different thicknesses depending on regions. Therefore, a flow of magnetic flux in a core may be appropriately controlled to improve direct current (DC) bias characteristics. In detail, as illustrated in FIGS. 2 and 3, a part formed at the outermost portion of the coil pattern 103, that is, a part of the coil pattern 102 adjacent to the lead portion T, and a part of the coil pattern 103 closest to the core region C may have a thickness less than that of internal patterns positioned therebetween. That is, the coil patterns 103 may be formed at a thickness greater in a central region thereof than in an outer region thereof. As an example of this form, the coil pattern 103 may have a thickness that is gradually increased from the outermost portion thereof and a region thereof adjacent to the core region C toward the central region (central region of the coil pattern). In addition, as shown in FIGS. 2 and 3, in order to secure convenience of a process, a part formed at the outermost portion of the coil pattern 103 and a part of the coil pattern 103 closest to the core region C may have the same thickness. Additionally or separately, the internal patterns positioned between the part formed at the outermost portion of the coil pattern 103 and the part of the coil pattern 103 closest to the core region C may also have the same thickness.

Since the coil patterns 103 have non-uniform thickness distribution, the coil patterns 103 may have a flow of magnetic flux as illustrated by an arrow in FIG. 2. That is, at the time of an operation of the coil electronic component, a boundary surface of the flow of the magnetic flux may have a shape similar to a curved surface. Therefore, saturation of the magnetic flux may be delayed. In a case in which the saturation of the magnetic flux is delayed as described above, DC bias characteristics of the coil electronic component may be improved.

Meanwhile, the non-uniform thickness distribution of the coil patterns 103 may be appropriately determined in order to smoothly control the flow of the magnetic flux. In detail, when a thickness of any one of the internal coil patterns formed at a relatively increased thickness in the coil pattern 103 is a and a thickness of the part of the coil pattern 103 closest to the core region C is b, thickness distribution may be determined so that a condition of 2a/3≦b<a is satisfied. Likewise, when a thickness of any one of the internal patterns formed at a relatively increased thickness in the coil pattern 103 is a and a thickness of the part formed at the outermost portion of the coil pattern 103 (that is, a part of the coil pattern 103 adjacent to the lead portion T) is b, thickness distribution may be determined so that a condition of 2a/3≦b<a is satisfied. When a difference between a thickness of a part formed at an outer portion of the coil pattern 103 and a thickness of the internal patterns of the coil pattern 103 is excessively large, for example, when 2a/3>b, a flow of magnetic flux may not be smooth, and it may be difficult to implement a high level of inductance. However, although a thickness of the part adjacent to the lead portion and a thickness of the part close to the core region C are the same as each other according to the present exemplary embodiment, the present disclosure is not limited thereto. According to another embodiment, a thickness of the part adjacent to the lead portion and a thickness of the part close to the core region C may also be different from each other as long as the above-mentioned condition for the thickness distribution is satisfied.

The body region 101 may have a form in which at least the core region C of the coil pattern 103 is filled with magnetic material, or the like, and may form an appearance of the coil electronic component 100 as in the present exemplary embodiment. In this case, the body region 101 may be formed of any material that possesses a magnetic property, and may be formed by providing, for example, ferrite or metal magnetic particles in a resin part.

As a specific example of these materials, the ferrite may be a material such as Mn—Zn based ferrite, Ni—Zn based ferrite, Ni—Zn—Cu based ferrite, Mn—Mg based ferrite, Ba based ferrite, Li based ferrite, or the like, and the body region 101 may have a form in which the ferrite particles are dispersed in a resin such as epoxy, polyimide, or the like.

In addition, the metal magnetic particle may contain one or more selected from the group consisting of Fe, Si, Cr, Al, and Ni. For example, the metal magnetic particle may be a Fe—Si—B—Cr based amorphous metal, but is not necessarily limited thereto. The metal magnetic particles may have a diameter of about 0.1 μm to 30 μm, and the body region 101 may have a form in which the metal magnetic particles are dispersed in a resin such as epoxy, polyimide, or the like, similar to the ferrite particles described above.

Method of Manufacturing Coil Electronic Component

Hereinafter, an example of a method of manufacturing the coil electronic component 100 having the structure described above will be described. Again referring to FIGS. 1 through 3, first, the coil pattern 103 may be formed on the substrate 102. Here, the coil pattern 103 may be formed using, preferably, a plating process, but is not necessarily limited thereto. As described above, the coil pattern 103 may include a main region having the spiral shape and the lead portion T connected to the main region and disposed at the outermost portion. In addition, as described above, the part formed at the outermost portion of the coil pattern 103, that is, the part adjacent to the lead portion T, and the part closest to the core region C may have a thickness less than that of the internal patterns positioned therebetween. That is, the coil patterns 103 may be formed at a thickness greater in a central region thereof than in an outer region thereof. The adjustment of the thickness described above may be implemented by a method of differently adjusting a plating time in each region, or the like.

Meanwhile, although not separately illustrated, an insulating layer coating the coil pattern 103 may be formed in order to protect the coil pattern 103. The insulating layer may be formed by a known method such as a screen printing method, an exposure and development method of a photo-resist (PR), a spray applying method, or the like.

Next, as an example of forming the body region 101, magnetic sheets may be stacked on and beneath the substrate 102 on which the coil pattern 103 is formed, compressed, and then hardened. The magnetic sheets may be manufactured in a sheet shape by mixing metal magnetic powder and organic materials such as a binder, a solvent, and the like, with each other to prepare a slurry, applying the slurry at a thickness of several tens of micrometers onto carrier films by a doctor blade method, and then drying the applied slurry.

The through-hole for the core region C may be formed in the central region of the substrate 102 using a method such as mechanical drilling, laser drilling, sand blasting, punching, or the like. The through-hole may be filled with the magnetic material at the time of stacking, compressing, and hardening the magnetic sheets to form the core region C.

Next, first and second external electrodes 111 and 112 may be formed on surfaces of the body region 101 so as to be each connected to the lead portions T exposed to both surfaces of the body region 101. The external electrodes 111 and 112 may be formed of a paste containing a metal having excellent electrical conductivity, such as a conductive paste containing nickel (Ni), copper (Cu), tin (Sn), silver (Ag), or alloys thereof. In addition, plating layers (not illustrated) may be further formed on the external electrodes 111 and 112. In this case, the plating layers may contain one or more selected from the group consisting of nickel (Ni), copper (Cu), and tin (Sn). For example, nickel (Ni) layers and tin (Sn) layers may be sequentially formed in the plating layers.

A description of features overlapping those of the coil electronic component according to the exemplary embodiment described above except for the above-mentioned description will be omitted.

As set forth above, according to an exemplary embodiment, the thickness of the coil pattern included in the coil electronic component may be appropriately adjusted to control the flow of magnetic flux in the core, thereby improving DC bias characteristics.

While exemplary embodiments have been shown and described above, it will be apparent to those skilled in the art that modifications and variations could be made without departing from the scope of the present invention as defined by the appended claims.

What is claimed is:

1. A coil electronic component comprising:
a substrate;
a coil pattern formed on at least one of first and second main surfaces of the substrate; and
a body region filling at least a core region of the coil pattern and having a magnetic material,
wherein a part formed at an outermost portion of the coil pattern and a part of the coil pattern closest to the core region have a thickness less than that of internal patterns positioned therebetween.

2. The coil electronic component of claim 1, wherein the coil pattern has a thickness that is gradually increased from the outermost portion thereof and a region thereof adjacent to the core region toward a central region thereof.

3. The coil electronic component of claim 1, wherein a thickness a of any one of the internal patterns of the coil pattern and a thickness b of the part of the coil pattern closest to the core region satisfy 2a/3≦b<a.

4. The coil electronic component of claim 1, wherein when a thickness a of any one of the internal patterns of the coil pattern and a thickness b of the part formed at the outermost portion of the coil pattern satisfy 2a/3≦b<a.

5. The coil electronic component of claim 1, wherein thicknesses of the part formed at the outermost portion of the coil pattern and the part of the coil pattern closest to the core region are the same as each other.

6. The coil electronic component of claim 1, wherein thicknesses of the internal patterns are the same as each other.

7. The coil electronic component of claim 1, wherein thicknesses of the part formed at the outermost portion of the coil pattern and the part of the coil pattern closest to the core region are the same as each other, and
thicknesses of the internal patterns of the coil pattern are the same as each other.

8. The coil electronic component of claim 7, wherein 2a/3≦b<a is satisfied, in which a is the thicknesses of the internal patterns of the coil pattern and b is the thicknesses of the part formed at the outermost portion of the coil pattern and the part of the coil pattern closest to the core region.

9. The coil electronic component of claim 1, wherein the coil pattern is formed by plating.

10. The coil electronic component of claim 1, wherein the coil pattern includes first and second coil patterns disposed on the first and second main surfaces of the substrate, respectively.

11. The coil electronic component of claim 1, wherein the coil pattern includes a lead portion exposed to the outside of the body region.

12. The coil electronic component of claim 11, further comprising external electrodes formed on surfaces of the body region and connected to the lead portion.

13. The coil electronic component of claim 11, wherein the lead portion and the outermost portion of the coil pattern have the same thickness.

14. The coil electronic component of claim 1, wherein the body region contains metal magnetic powder and a thermosetting resin.

15. A coil electronic component comprising:
a substrate having a through hole;
a coil pattern formed on the substrate; and
a body region filling the through hole of the substrate and embedding the substrate and the coil pattern,
wherein a thickness of the coil pattern first increases and then decreases along a direction from an edge of the substrate toward the through hole of the substrate.

16. The coil electronic component of claim 15, wherein the greatest thickness a of the coil pattern and the smallest thickness b of the coil pattern satisfy 2a/3≦b<a.

17. The coil electronic component of claim 15, wherein thicknesses of an outermost portion of the coil pattern and a portion of the coil pattern closest to the through hole are the same as each other.

18. The coil electronic component of claim 15, wherein thicknesses of internal patterns of the coil patterns are the same as each other.

19. The coil electronic component of claim 15, wherein the coil pattern includes a lead portion exposed to the outside of the body region,
the coil electronic component further comprises external electrodes formed on surfaces of the body region and connected to the lead portion.

20. The coil electronic component of claim 19, wherein the lead portion and an outermost portion of the coil pattern have the same thickness.
